(19) United States
(12) Patent Application Publication
(10) Pub. No.: US 2010/0079112 A1
(43) Pub. Date: Apr. 1, 2010

(54) Battery controller, battery control method, and battery

(75) Inventor: Osamu Nagashima, Tokyo (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/586,640

(22) Filed: Sep. 25, 2009

(30) Foreign Application Priority Data
Oct. 1, 2008 (JP) P2008-256676

(51) Int. Cl. H02J 7/00

(52) U.S. Cl. 320/134

(57) ABSTRACT

A battery controller includes: a temperature detecting section including at least one temperature detecting element whose resistance changes with changes in the temperature of a battery cell and/or a charge/discharge control switch connecting the cell with an external apparatus; first and second voltage divider circuits respectively including first and second resistive elements connected with the temperature detecting element; and a control section applying a reference voltage to the first or second voltage divider circuit while switching it such that the value of a voltage applied to the temperature detecting element according to a voltage dividing ratio between the resistive element and the voltage divider circuit changes proportionally to the temperature of the cell and/or the switch, and controlling the switch such that the external apparatus is connected to the cell when the temperature of the cell and/or the switch detected based on a voltage division output of the voltage divider circuit is between first and second temperatures.

### BACKGROUND OF THE INVENTION

1. Field of the Invention

The present invention relates to a battery controller exercising control for electrically connecting an external apparatus to a battery such as a lithium ion secondary cell, a battery control method, and a battery having the controller incorporated therein.

2. Description of the Related Art

When a battery pack utilizing a lithium ion secondary cell or the like as a battery cell is charged or discharged, it is very difficult to detect the temperature of the same accurately. Particularly, when a battery pack is continuously charged or discharged by a charging current or discharging current equal to or higher than an allowable current of a battery cell or a charge/discharge control switch constituted by an FET (field effect transistor), the battery cell or the charge/discharge control switch is overheated. Therefore, when the temperature of a battery cell exceeds a certain threshold during a battery charging or discharging operation according to the related art, the supply of the charging current or discharging current from the charger is stopped. Alternatively, the charging path or discharging path of the battery pack is blocked.

For example, JP-A-2004-242459 (Patent Document 1) discloses a charging circuit which accurately detects that a battery has been fully charged in controlling the charging of the battery with reference to the temperature thereof, the circuit controlling the charging of the battery based on temporal changes in a difference between the temperature of the battery and the temperature of a part that is less affected by a temperature rise at the battery.

### SUMMARY OF THE INVENTION

As described above, it is desirable to prevent the temperature of a battery cell or a charge/discharge control switch (hereinafter referred to as “battery cell or the like”) from exceeding a certain upper limit. When a battery cell is continuously used in an environment at a low temperature, shorting can occur in the cell. Further, a charge/discharge control switch has a high on-resistance when it is constituted by an FET, and such a switch can be overheated when charged or discharged. Under the circumstance, accurate temperature detection is desirable even when such an element is at a low temperature.

Controllers for controlling operations of a battery or charge/discharge control switch according to the related art have been designed to achieve high detection accuracy only in detecting high temperatures in order to prevent the temperature of a battery cell from exceeding a certain upper limit. When such a design is employed, temperature detection is carried out to improve the accuracy of detection of high temperatures taking the temperature characteristics of a thermistor into consideration. However, in the temperature characteristics of a thermistor, the linearity of a temperature-resistance relationship is not maintained over a wide range of temperatures including low and high temperatures. As a result, when high detection accuracy is achieved in one region of temperatures, the accuracy of detection can be lower in another region of temperatures. Therefore, it has not been possible to detect the temperature of a battery cell or the like accurately over a wide range of temperatures including low and high temperatures with controllers according to the related art.

In consideration to such circumstances, it is desirable to provide a battery controller which accurately detects the temperature of a battery cell or the like over a wide range of temperatures and which controls an operation of electrically connecting the battery cell with an external apparatus based on results of the detection while suppressing the cost of such a controller. It is also desirable to provide a battery control method for the controller and a battery having the controller incorporated therein.

According to an embodiment of the invention, there is provided a battery controller including a temperature detecting section including at least one temperature detecting element whose resistance changes with changes in the temperature of a battery cell and/or a charge/discharge control switch electrically connecting the battery cell with an external apparatus (hereinafter referred to as “battery cell or the like”), a first voltage divider circuit including a first resistive element connected in series with the temperature detecting element of the temperature detecting section, a second voltage divider circuit including a second resistive element connected in series with the temperature detecting element of the temperature detecting section, and a control section applying a reference voltage to either of the first and second voltage divider circuits while switching the voltage divider circuit to apply the reference voltage such that the value of a voltage applied to the temperature detecting element according to a voltage dividing ratio between the first resistive element or the second resistive element and the voltage divider circuit changes in proportion to changes in the temperature of the battery cell or the like. The control section controls the charge/discharge control switch such that the external apparatus is electrically connected to the battery cell when the temperature of the battery cell or the like detected based on a voltage division output of the voltage divider circuit is not lower than a first temperature and not higher than a second temperature.

According to another embodiment of the invention, there is provided a battery control method including the step of applying a reference voltage to either of a first voltage divider circuit including a first resistive element and a second voltage divider circuit including a second resistive element while switching the voltage divider circuit to apply the reference voltage. The first resistive element is connected in series with at least one temperature detecting element and has resistance changing with changes in the temperature of a battery and/or a charge/discharge control switch electrically connecting the battery cell with an external apparatus (hereinafter referred to as “battery cell or the like). The second resistive element is connected in series with the temperature detecting element. The reference voltage is applied such that a voltage applied to the temperature detecting element according to a voltage dividing ratio between the first resistive element or the second resistive element and the voltage divider circuit changes in proportion to changes in the temperature of the battery cell or the like. The method also includes the step of controlling the charge/discharge control switch such that the external apparatus is electrically connected to the battery cell when the temperature of the battery cell or the like detected based on a voltage division output from the voltage divider circuit to which the reference voltage is applied is not lower than a first temperature and not higher than a second temperature.

According to still another embodiment of the invention, there is provided a battery including a battery cell, a charge/discharge control switch electrically connecting the battery cell with an external apparatus, at least one temperature detecting element whose resistance changes with changes in the temperature of a battery cell and/or a charge/discharge control switch electrically connecting the battery cell with an external apparatus (hereinafter referred to as “battery cell or the like”), a first voltage divider circuit including a first resistive element connected in series with the temperature detecting element, a second voltage divider circuit including a second resistive element connected in series with the temperature detecting element, and a control section applying a reference voltage to either of the first and second voltage divider circuits while switching the voltage divider circuit to apply the reference voltage such that a voltage applied to the temperature detecting element according to a voltage dividing ratio between the first resistive element or the second resistive element and the voltage divider circuit changes in proportion to changes in the temperature of the battery cell or the like. The control section controls the charge/discharge control switch such that the external apparatus is electrically connected to the battery cell when the temperature of the battery cell or the like detected based on a voltage division output of the voltage divider circuit is not lower than a first temperature and not higher than a second temperature.

According to the embodiments of the invention, the temperature of the battery cell or the charge/discharge control switch can be accurately detected over a wide range of temperatures by applying a reference voltage to either of the first voltage divider circuit or the second voltage divider circuit while switching the voltage divider circuit to apply the voltage and detecting a voltage division output from the circuit. According to the embodiments of the invention, the operation of a battery pack can be controlled based on a detected temperature of a battery or a charge/discharge control switch while suppressing an increase in the cost of the same as compared with a case where, for example, a storage element is provided for storing in advance a table indicating a nonlinear characteristics between the voltage and the temperature of the temperature detecting element.

### BRIEF DESCRIPTION OF THE DRAWINGS

FIG. 1 is a diagram showing a general configuration of a battery pack embodying the invention;

FIG. 2 is a diagram showing a specific circuit configuration of a processing system associated with temperature detection among features mounted on a control substrate;

FIG. 3 is a graph for explaining temperature characteristics of temperature detecting elements mounted on the control substrate;

FIG. 4 is a flow chart for explaining a flow of processes associated with temperature detection performed by a control section 3b;

FIG. 5 is a graph for explaining changes in the temperatures of the temperature detecting elements and a battery cell depending on changes in the ambient temperature of the battery pack;

FIG. 6 is a flow chart for explaining a process of correcting a temperature detected by a temperature detecting element TH1 or TH2; and

FIG. 7 is a diagram showing a specific circuit configuration of a processing system associated with temperature detecting among features on a control substrate according to a second embodiment of the invention.

### DETAILED DESCRIPTION OF THE INVENTION

Embodiments of the invention will now be described with reference to the drawings. The invention is not limited to the embodiments described below, and various modifications may obviously be made to the embodiments without departing from the spirit of the invention. The description will be made in the following order.

1. First Embodiment

2. Second Embodiment

### 1. First Embodiment

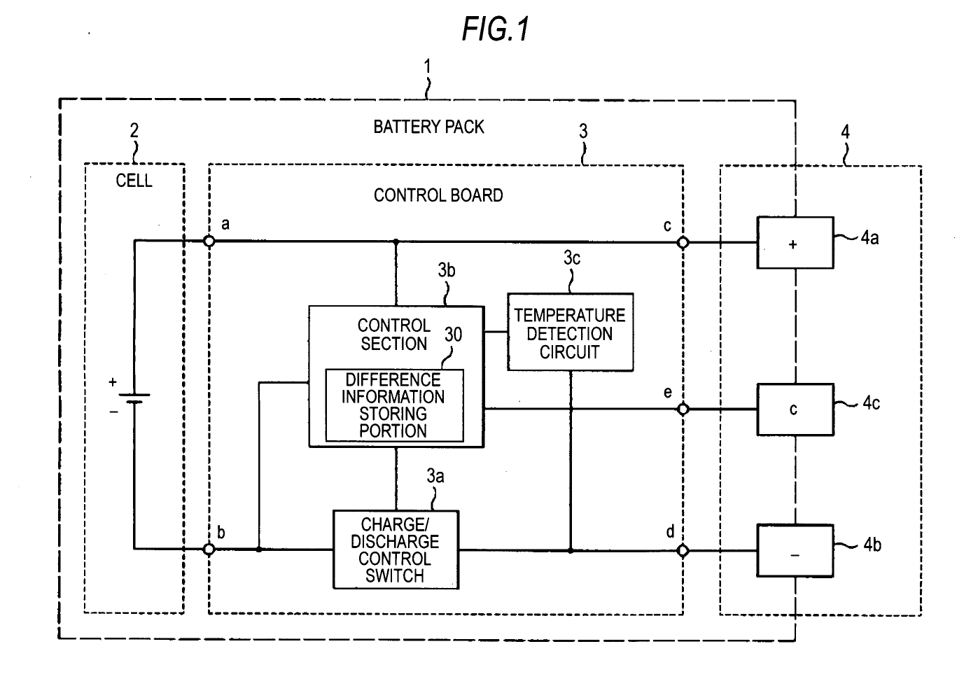

A battery controller embodying the invention is a device for controlling electrical connection between a battery cell such as a lithium ion secondary cell and an external apparatus, and the controller is incorporated in, for example, a battery pack 1 as shown in FIG. 1.

As shown in FIG. 1, the battery pack 1 includes a battery cell 2, a control substrate 3 for controlling operations of the battery cell 2, and an input/output section for establishing electrical connection between the battery cell 2 and an external apparatus.

The battery cell 2 is a chargeable and dischargeable battery such as a lithium ion secondary cell, and the cell is connected to the control substrate 3 at contacts a and b to be controlled by the same when electrically connected to an external apparatus.

The control substrate 3 has a charge/discharge control switch 3a mounted thereon for electrically connecting and disconnecting the battery cell 2 and the input/output section 4 to control operations of the battery cell 2 connected to the substrate through the contacts a and b. The control substrate 3 also carries a control section 3b controlling switching operations of the charge/discharge control switch 3a and a temperature detecting circuit 3c detecting the temperature of at least either of the battery cell 2 and the charge/discharge control switch 3a (those elements will hereinafter be referred to as “battery cell 2 or the like”).

The charge/discharge control switch 3a is constituted by a switching element such as an FET, and the switch controls electrical connection and disconnection at a contact b and a contact d according to control signals from the control section 3b to control electrical connection between the battery cell 2 and an external apparatus.

The control section 3b drives the temperature detecting circuit 3c and controls operations of the charge/discharge control switch 3a based on results of detection performed by the temperature detecting circuit 3c. The control section 3b includes a difference information storing portion 30 provided in a storage area of an internal memory of the same for storing difference information indicating a temperature difference between a temperature detected by the temperature detecting circuit 3c and the temperature of the battery cell 2 or the like.

The temperature detecting circuit 3c includes temperature detecting elements whose resistance changes with changes in the temperature of the battery cell 2 or the like. A voltage applied to voltage divider circuits which include the temperature detecting elements is controlled by the control section 3b as will be described later.

The input/output section 4 includes a positive terminal 4a which is connected to the control substrate 3 through a contact c, a negative terminal 4b which is connected to the control substrate 3 through the contact d, and a communication portion 4c which is connected to the control substrate 3 through a contact e and which communicates with an external apparatus. The input/output section 4 is connected to a charging apparatus which charges the battery cell 2 or a load apparatus which is to be supplied with power from the battery cell 2. The communication portion 4c is connected to the charging apparatus or load apparatus in a communicable manner, and the portion provides information supplied by the control section 3b to the external apparatus.

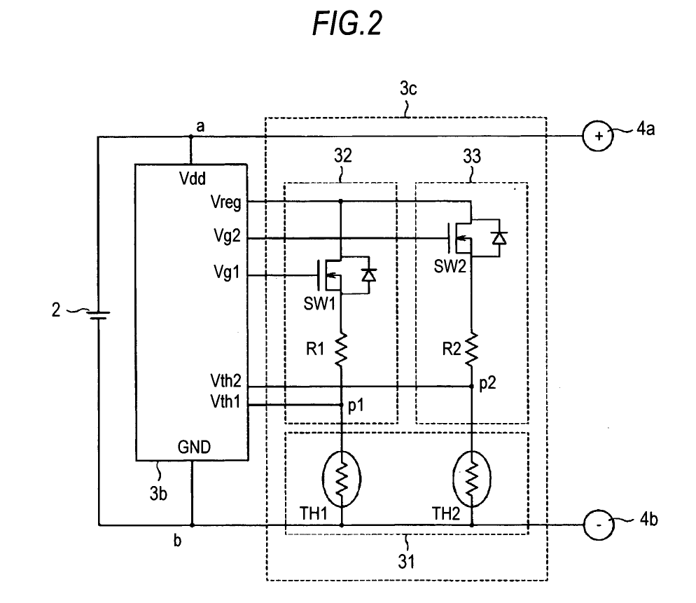

The battery pack 1 configured as thus described employs a circuit configuration as shown in FIG. 2 to allow the control substrate 3 to accurately detect the temperature of the battery cell 2 or the like and to control operations of charging and discharging the battery cell 2 based on results of the detection.

FIG. 2 is a diagram showing a specific circuit configuration of the control section 3b and the temperature detecting circuit 3c which are features serving as a processing system associated with temperature detection among the features mounted on the control substrate 3.

Specifically, the control section 3b includes a Vdd terminal electrically connected to a positive terminal of the battery cell 2 through the contact a and a GND terminal electrically connected to a negative terminal of the battery cell 2 through the contact b. The control section 3b also includes a Vreg terminal connected to each of a first voltage divider circuit 32 and a second voltage divider circuit 33 of the temperature detecting circuit 3c which will be described later for applying a reference voltage to the circuits. The control section 3b also includes a Vg1 terminal for controlling a switching element SW1 of the temperature detecting circuit 3c which will be described later and a Vg2 terminal for controlling a switching element SW2 of the temperature detecting circuit 3c which will be described later. The control section 3b also includes a Vth1 terminal connected to a positive end p1 of a temperature detecting element TH1 of the temperature detecting circuit 3c which will be described later and a Vth2 terminal connected to a positive end p2 of a temperature detecting element TH2 of the temperature detecting circuit 3c which will be described later.

The temperature detecting circuit 3c includes a temperature detecting portion 31 which is formed by the two temperature detecting elements TH1 and TH2 and the first voltage divider circuit 32 and the second voltage divider circuit 33 for switching the operations of the temperature detecting portion 31.

The temperature detecting portion 31 is formed by the two temperature detecting elements TH1 and TH21, and negative ends of both of the temperature detecting elements TH1 and TH2 are connected in parallel with the negative terminal of the battery cell 2. The temperature detecting element TH1 is a resistive element whose resistance changes with changes in the temperature of the battery cell 2 as described above, and the element is connected in series with the first voltage divider circuit 32 at the positive end p1. The temperature detecting element TH2 is a resistive element whose resistance changes with changes in the temperature of the battery cell 2 as described above, and the element is connected in series with the second voltage divider circuit 33 at the positive end p2.

The first voltage divider circuit 32 includes a first resistive element R1 which is connected in series with the temperature detecting element TH1 and the switching element SW1 which controls electrical connection and disconnection between the first resistive element R1 and the Vreg terminal of the control section 3b.

Specifically, the first resistive element R1 is a resistive element whose resistance undergoes temperature-dependent changes small enough for the temperature detecting element TH1 to ignore. The switching element SW1 is constituted by, for example, an N-channel MOSFET. When a gate voltage applied from the Vg1 terminal becomes a high level, the element electrically connects the first resistive element R1 with the Vreg terminal of the control section 3b. When the gate voltage applied from the Vg1 terminal becomes a low level, the element breaks the electrical connection. Thus, when the gate voltage applied from the Vg1 terminal becomes the high level, the first resistive element R1 and the temperature detecting element TH1 are pulled up to the value of a reference voltage applied from the Vreg terminal.

The second voltage divider circuit 33 includes a second resistive element R2 which is connected in series with the temperature detecting element TH2 and the switching element SW2 which controls electrical connection and disconnection between the second resistive element R2 and the Vreg terminal of the control section 3b.

Specifically, the second resistive element R2 is a resistive element whose resistance undergoes temperature-dependent changes small enough for the temperature detecting element TH2 to ignore. The switching element SW2 is constituted by, for example, an N-channel MOSFET. When a gate voltage applied from the Vg2 terminal becomes a high level, the element electrically connects the second resistive element R2 with the Vreg terminal of the control section 3b. When the gate voltage applied from the Vg2 terminal becomes a low level, the element breaks the electrical connection. Thus, when the gate voltage applied from the Vg2 terminal becomes the high level, the second resistive element R2 and the temperature detecting element TH2 are pulled up to the value of a reference voltage applied from the Vreg terminal.

The control section 3b on the control substrate 3 having the above-described circuit configuration controls the switching elements SW1 and SW2 through the Vg1 and Vg2 terminals to apply a reference voltage to either of the first voltage divider circuit 32 and the second voltage divider circuit 33 while switching the voltage divider circuit to apply the reference voltage. When the reference voltage is applied to the first voltage divider circuit 32, the control section 3b detects at the Vth1 terminal thereof a voltage applied to the temperature detecting element TH1 according to a voltage dividing ratio between the first resistive element R1 and the same to perform temperature detection. Similarly, when the reference voltage is applied to the second voltage divider circuit 33, the control section 3b detects at the Vth2 terminal thereof a voltage applied to the temperature detecting element TH2 according to a voltage dividing ratio between the second resistive element R2 and the same to perform temperature detection.

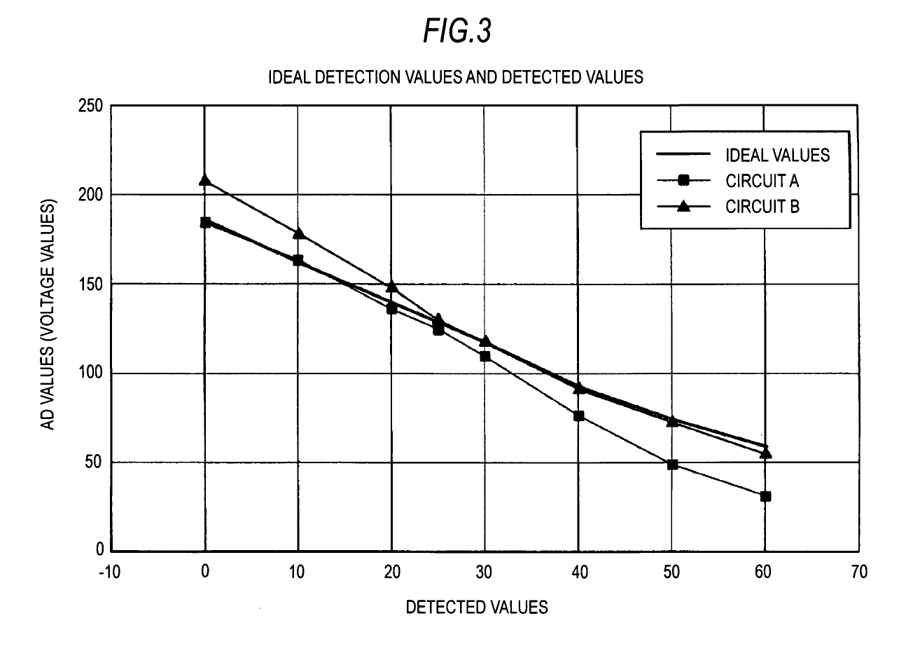

On the control substrate 3 having connections in relationships as described above, in order to accurately detect the temperature of the battery cell or the like over a wide range of temperatures, for example, the temperature detecting element TH1 is used for detecting high temperatures with the temperature detecting element TH2 used for detecting low temperatures. Specifically, when it is assumed that the control substrate 3 is to detect temperatures in the range from 0° C. to 60° C., the temperature detecting element TH1 detects temperature changes within the range from 30° C. to 60° C., and the temperature detecting element TH2 detects temperature changes within the range from 0° C. to 30° C. The characteristics of the elements forming the first voltage divider circuit 32 on the control substrate 3 are determined such that the value of the voltage applied to the temperature detecting element TH1 changes in proportion to changes in the temperature of the battery cell 2 or the like in the high temperature range from 30° C. to 60° C. as shown in FIG. 3. The characteristics of the elements forming the second voltage divider circuit 33 on the control substrate 3 are determined such that the value of the voltage applied to the temperature detecting element TH2 changes in proportion to changes in the temperature of the battery cell 2 or the like in the low temperature range from 0° C. to 30° C.

With the characteristics of the elements of each voltage divider circuit determined as thus described, the control section 3b applies a reference voltage to either of the first voltage divider circuit 32 and the second voltage divider circuit 33 while switching the circuit to apply the reference voltage such that the values of the voltages applied to the temperature detecting element TH1 and TH2 change in proportion to changes in the temperature of the battery cell 2 or the like. The control section 3b detects voltage division outputs from the voltage divider circuits changing in proportion to changes in the temperature of the battery cell 2 or the like within the respective temperature ranges, the outputs being detected at the Vth1 terminal and the Vth2 terminal. A voltage value associated with such a voltage division output is multiplied by a predetermined conversion coefficient to obtain a detected temperature value. Since the control section 3b obtains detected temperatures by multiplying the values of voltages applied to the temperature detecting elements TH1 and TH2 by a predetermined conversion coefficient as thus described, the temperature of the battery cell 2 or the like can be accurately detected over a wide range of temperatures.

Instead of the above-described temperature detecting method, for example, a table showing non-linear characteristics existing between the voltages of the temperature detecting elements and temperatures may be stored in a storage element in advance, and the table may be referred to when detecting temperatures as means for performing accurate temperature detection over a wide range of temperatures. Unlike such an alternative method, the control substrate 3 needs neither storage element nor storage area for implementing a table as described above. Further, the use of the control substrate 3 allows a detected temperature to be obtained only by adjusting the characteristics of the elements forming each voltage divider circuit and multiplying a voltage value by a predetermined conversion coefficient. Thus, the temperature of the battery cell 2 or the like can be accurately detected over a wide range of temperatures while suppressing an increase in the cost.

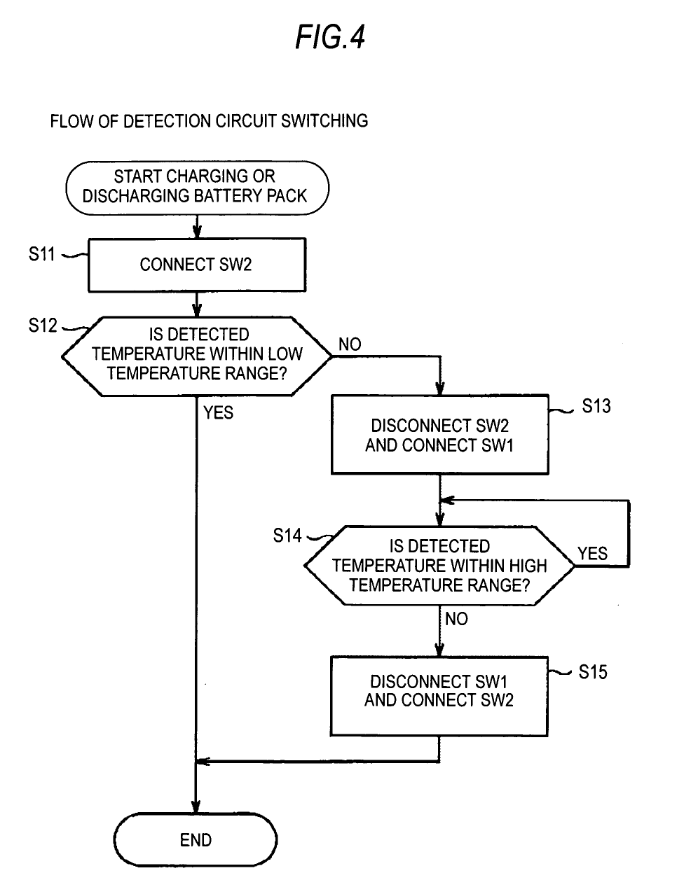

A flow of a process associated with temperature detection performed by the control section 3b will now be described with reference to FIG. 4. The premise of the process is that the detection of the temperature of the battery cell 2 or the like is started as the control section 3b controls the charge/discharge control switch 3a to start electrically connecting the battery cell 2 with an external apparatus.

At step S11, the control section 3b controls the gate voltage applied from the Vg2 terminal to electrically connect the switching element SW2. Thus, the control section 3b applies a reference voltage to the second voltage divider circuit 33 and obtains a detected temperature by converting a voltage value associated with a voltage division output from the circuit into a temperature. The process then proceeds to step S12.

At step S12, the control section 3b determines whether the temperature detected by the temperature detecting element TH2 is within the low temperature range from 0° C. to 30° C. or not. When the detected temperature is within the low temperature range, the control section 3b causes the temperature detecting element TH2 to continue the temperature detecting process and terminates this step. When the detected temperature is out of the low temperature range, the control section 3b proceeds to step S13.

At step S13, the control section 3b controls the gate voltage applied from the Vg2 terminal to electrically disconnect the switching element SW2 and controls the gate voltage applied from the Vg1 terminal to electrically connect the switching element SW1. Thus, the control section 3b applies a reference voltage to the first voltage divider circuit 32 and obtains a detected temperature by converting a voltage value associated with a voltage division output from the circuit into a temperature. The process then proceeds to step S14.

At step S14, the control section 3b determines whether the temperature detected by the temperature detecting element TH1 is within the high temperature range from 30° C. to 60° C. or not. The control section 3b repeats this step at a predetermined cycle until the detected temperature becomes out of the high temperature range and proceeds to step S15 when the detected temperature becomes out of the high temperature range.

At step S15, the control section 3b controls the gate voltage applied from the Vg1 terminal to electrically disconnect the switching element SW1 and controls the gate voltage applied from the Vg2 terminal to electrically connect the switching element SW2. Thus, the control section 3b applies a reference voltage to the second voltage divider circuit 33 and obtains a detected temperature by converting a voltage value associated with a voltage division output from the circuit into a temperature. Then, this step is terminated.

As thus described, the control section 3b applies a reference voltage to either of the first voltage divider circuit 32 and the second voltage divider circuit 33 while switching the circuit to apply the reference voltage. Then, the value of a resultant voltage division output or the value of a resultant voltage applied to the temperature detecting element TH1 or TH2 is detected. Thus, the temperature of the battery cell 2 or the like can be accurately detected over a wide range of temperatures while suppressing an increase in the cost. In order to prevent the temperature of the battery cell 2 or the like from becoming excessively low or high, the control section 3b causes the charge/discharge control switch 3a to operate when the temperature is within a temperature range from 0° C. to 60° C. As a result, the control section 3b can control the electrical connection between the battery cell 2 or the like and an external apparatus based on a detected temperature of the battery cell 2 or the like such that the battery cell 2 will not be overheated.

The control section 3b may leave the battery cell 2 or the like in electrical connection with an external apparatus even when a detected temperature is out of the temperature range from 0° C. to 60° C. For example, the connection may be maintained until predetermined time passes after the temperature of the battery cell 2 or the like falls below 0° C. Thus, the control section 3b allows the battery cell 2 to be kept in electrical connection with an external apparatus as long as possible. The reason is as follows. The temperature detecting elements TH1 and TH2 detect the temperature of the battery cell 2 or the like on the surface of the same. It takes some time for the internal temperature of the battery cell 2 to fall below 0° C., and the battery cell can therefore be operated taking such a time lag into consideration.

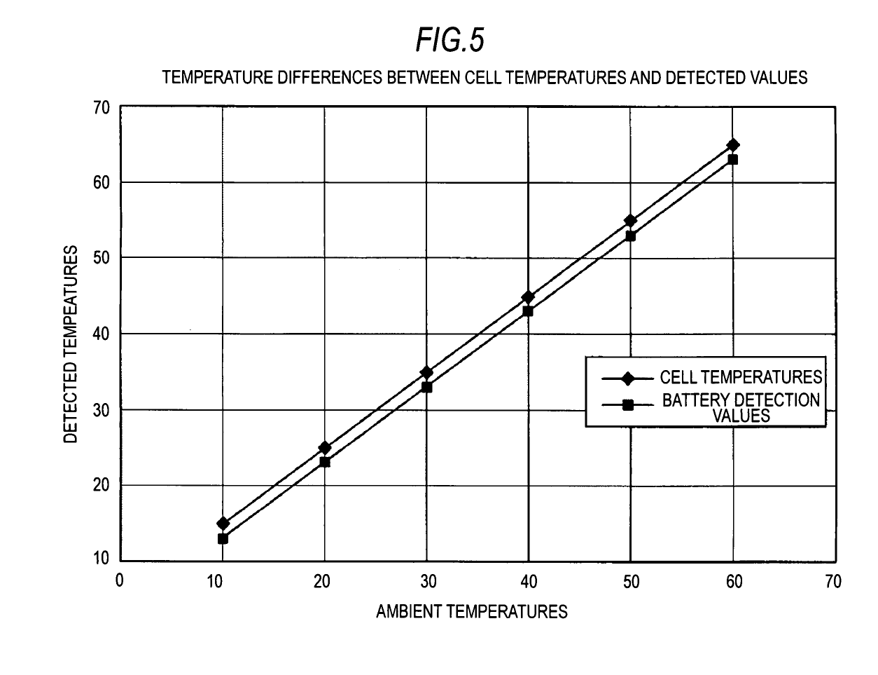

When the control substrate 3 operates under such physical conditions that various members are disposed at a high density just as in the battery pack 1, the battery cell 2 and the charge/discharge control switch 3a may be disposed in positions apart from the temperature detecting elements TH1 and TH2. In such a case, the temperature of the battery cell 2 or the like may be detected with degraded accuracy. Although temperature detection can be performed with high accuracy when the temperature detecting elements TH1 and TH2 are directly mounted on the battery cell 2 or the charge/discharge control switch 3a, it is difficult to mount them in such a manner in an actual product. For example, as shown in FIG. 5, there is disagreement or errors between temperature changes detected when the temperature detecting elements TH1 and TH2 are apart from the battery cell 2 or the charge/discharge control switch 3a and temperature changes measured by putting a temperature sensor in contact with the battery, cell 2 or charge/discharge control switch 3a, depending on the ambient temperature of the battery pack 1.

Under the circumstance, the control section 3b on the control substrate 3 corrects a temperature detected by the temperature detecting element TH1 or TH2 using difference information stored in the difference information storing section 30 provided therein, thereby improving the accuracy of the detected temperature.

The difference information storing section 30 is provided on an internal memory of the control section 3b as described above for storing difference information indicating temperature differences between temperatures detected by the temperature detecting elements TH1 and TH2 and temperatures of the battery cell 2 or the like. Specifically, the difference information is the value of a temperature difference between a temperature detected by the temperature detecting element TH1 or TH2 and the actual temperature of the battery cell 2 or the like measured at each ambient temperature, at each charging or discharging current, or in each manner in which battery cells 2 are stacked. Difference information obtained by actual measurement as thus described is stored in the difference information storing section 30.

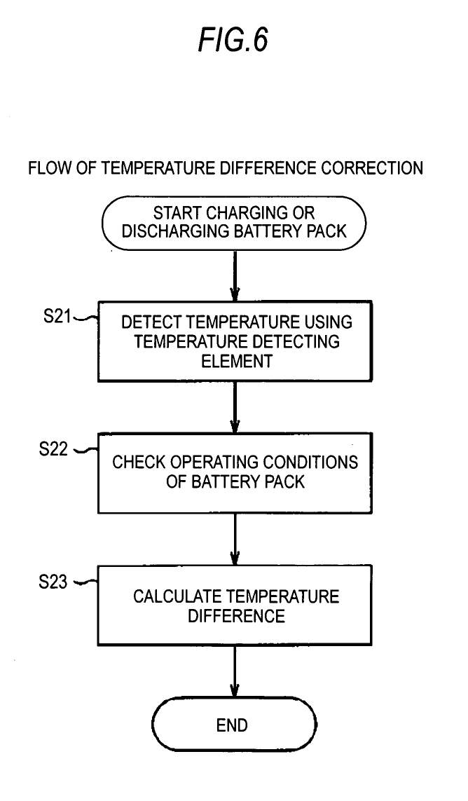

The control section 3b corrects a temperature detected by the temperature detecting elements TH1 and TH2 according to the flow chart shown in FIG. 6 using the difference information storing section 30 having difference information as thus described stored therein.

First, the control section 3b starts the process of detecting the temperature of the battery cell 2 or the like when the charge/discharge control switch 3a is controlled to start the operation of charging or discharging the battery cell 2.

At step S21, the control section 3b takes steps S11 to S15 described above to detect the temperature of the battery cell 2 or the like using the temperature detecting elements TH1 and TH2, and the process thereafter proceeds to step S22.

At step S22, the control section 3b checks the operating conditions of the battery pack 1, i.e., the ambient temperature, whether it is charged or discharged, and the manner in which battery cells are stacked. The control section 3b reads difference information associated with the operating conditions thus identified from the difference information storing section 30 and proceeds to step S23.

At step S23, the control section 3b detects the temperature of the battery cell 2 or the like by subtracting a temperature indicated by difference information stored in the difference information storing section 30 from a detected temperature obtained by multiplying a voltage value according to a voltage division output applied to the temperature detecting element TH1 or TH2 by a predetermined conversion coefficient. Then, the control section 3b terminates the steps associated with the temperature detecting process. When the temperature of the battery cell 2 or the like is not lower than 0° C. and not higher than 60° C., the section controls the charge/discharge control switch 3a such that it charges or discharges the battery cell 2 or the like by electrically connecting an external apparatus to the cell.

As thus described, the control section 3b can accurately detect the temperature of the battery cell 2 or the like, the detection reflecting the operating conditions of the battery pack 1 and the disposition of the temperature detecting elements TH1 and TH2 relative to the battery cell 2 and the charge/discharge control switch 3a.

### 2. Second Embodiment

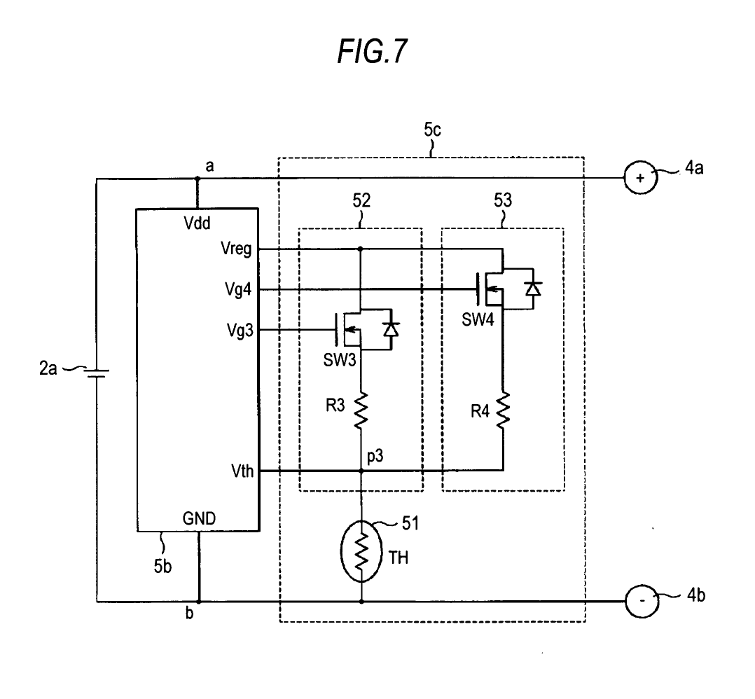

Although a battery pack 1 according to a second embodiment of the invention employs a control substrate 5 having only one temperature detecting element as shown in FIG. 7, the substrate allows the temperature of a battery cell 2 or the like to be accurately detected over a wide range of temperatures similarly to the control substrate 3 described above.

FIG. 7 is a diagram showing a specific circuit configuration of a control section 5b and a temperature detecting circuit 5c which are features forming a temperature detection process system among circuit features on the control substrate 5 having one temperature detecting element.

The control section 5b includes a Vdd terminal which is electrically connected to a positive terminal of a battery cell 2 through a contact a and a GND terminal which is electrically connected to a negative terminal of the battery cell 2 through a contact b. The control section 5b includes a Vreg terminal which is connected to each of a first voltage divider circuit 52 and a second voltage divider circuit 53 of the temperature detecting circuit 5c to be described later and which applies a reference voltage to the first voltage divider circuit 52 and the second voltage divider circuit 53. The control section 5b also includes a Vg3 terminal for controlling a switching element SW3 of the temperature detecting circuit 5c which will be described later and a Vg4 terminal for controlling a switching element SW4 of the temperature detecting circuit 5c which will be described later. The control section 5b also includes a Vth terminal connected to a positive end p3 of a temperature detecting element TH of the temperature detecting circuit 5c which will be described later.

The temperature detecting circuit 5c has a temperature detecting portion 51 including one temperature detecting element TH and the first voltage divider circuit 52 and the second voltage divider circuit 53 for switching operations of the temperature detecting portion 51.

The temperature detecting portion 51 includes one temperature detecting element TH, and a negative side of the temperature detecting element TH is connected in parallel with the negative terminal of the battery cell 2. The temperature detecting element TH is a resistive element whose resistance changes with changes in the temperature of the battery cell 2 or the like as described above, and the element is connected to the first voltage divider circuit 52 and the second voltage divider circuit 53 through the positive end p3.

The first voltage divider circuit 52 includes a first resistive element R3 which is connected to the temperature detecting element TH through a positive end p3 thereof and the switching element SW3 which controls electrical connection and disconnection between the first resistive element R3 and the Vreg terminal of the control section 5b.

Specifically, the first resistive element R3 is a resistive element whose resistance undergoes temperature-dependent changes small enough for the temperature detecting element TH to ignore. The switching element SW3 is constituted by, for example, an N-channel MOSFET. When a gate voltage applied from the Vg3 terminal becomes a high level, the element electrically connects the first resistive element R3 with the Vreg terminal of the control section 5b. When the gate voltage applied from the Vg3 terminal becomes a low level, the element breaks the electrical connection. Thus, when the gate voltage applied from the Vg3 terminal becomes the high level, the first resistive element R3 and the temperature detecting element TH are pulled up to the value of a reference voltage applied from the Vreg terminal.

The second voltage divider circuit 53 includes a second resistive element R4 which is connected to the temperature detecting element TH through the positive end p3 and the switching element SW4 which controls electrical connection and disconnection between the second resistive element R4 and the Vreg terminal of the control section 5b.

Specifically, the second resistive element R4 is a resistive element whose resistance undergoes temperature-dependent changes small enough for the temperature detecting element TH to ignore. The switching element SW4 is constituted by, for example, an N-channel MOSFET. When a gate voltage applied from the Vg4 terminal becomes a high level, the element electrically connects the second resistive element R4 to the Vreg terminal of the control section 5b. When the gate voltage applied from the Vg4 terminal becomes a low level, the element breaks the electrical connection. Thus, when the gate voltage applied from the Vg4 terminal becomes the high level, the second resistive element R4 and the temperature detecting element TH are pulled up to the value of a reference voltage applied from the Vreg terminal.

The control section 5b on the control substrate 5 having the above-described circuit configuration controls the switching elements SW3 and SW4 through the Vg3 and Vg4 terminals to apply a reference voltage to either of the first voltage divider circuit 52 and the second voltage divider circuit 53 while switching the voltage divider circuit to apply the reference voltage. When the reference voltage is applied to the first voltage divider circuit 52, the control section 5b detects at the Vth terminal thereof a voltage applied to the temperature detecting element TH according to a voltage dividing ratio between the first resistive element R3 and the circuit to perform temperature detection. Similarly, when the reference voltage is applied to the second voltage divider circuit 53, the control section 5b detects at the Vth terminal thereof a voltage applied to the temperature detecting element TH according to a voltage dividing ratio between the second resistive element R4 and the circuit to perform temperature detection.

When it is assumed that the control substrate 5 having the above-described circuit configuration is to detect temperatures in the range from 0° C. to 60° C. like the control substrate 3, the characteristics of the elements forming each voltage divider circuit are adjusted as follows. Specifically, the characteristics of the elements forming the first voltage divider circuit 52 on the control substrate 5 are determined such that the voltage applied to the temperature detecting element TH through the first voltage divider circuit 52 changes in proportion to changes in the temperature of the battery cell 2 or the like in a high temperature range from 30° C. to 60° C. The characteristics of the elements forming the second voltage divider circuit 53 on the control substrate 5 are determined such that the voltage applied to the temperature detecting element TH through the second voltage divider circuit 53 changes in proportion to changes in the temperature of the battery cell 2 or the like in a low temperature range from 0° C. to 30° C.

With the characteristics of the elements determined as thus described, the control section 5b applies a reference voltage to either of the first voltage divider circuit 52 and the second voltage divider circuit 53 while switching the circuit to apply the reference voltage such that the value of the voltage applied to the temperature detecting element TH changes in proportion to changes in the temperature of the battery cell 2 or the like. The control section 5b detects at the Vth terminal thereof a voltage which changes in proportion to changes in the temperature of the battery cell 2 or the like in each of the temperature ranges and multiplies the voltage by a predetermined conversion coefficient to obtain a detected temperature value. Since the control section 5b obtains a detected temperature by multiplying a voltage applied to the temperature detecting element TH by a predetermined conversion coefficient, the temperature of the battery cell 2 or the like can be accurately detected over a wide range of temperatures. Particularly, the control substrate 5 allows the temperature of the battery cell 2 or the like to be detected at a lower cost compared to the above-described control substrate 3 because it can operate with only one temperature detecting element.

The number of the temperature detecting elements in the battery pack 1 is not limited to the above description, i.e., one or two, as long as the control substrate is loaded with the temperature detecting element(s) such that a voltage applied to the element(s) changes in proportion to changes in the temperature of the battery cell 2 or the like. The battery pack 1 can be designed at a higher degree of flexibility with higher accuracy in detecting the temperature of the battery cell 2 or the like, the greater the number of the temperature detecting elements used therein.

The temperature of the battery cell 2 or the like accurately detected in a wide range of temperatures may be transmitted to the outside of the battery pack 1 through the communication section 4c. Such information on the temperature of the battery cell 2 or the like may be used as information for accurately estimating the charging capacity of the battery pack 1.

The present application contains subject matter related to that disclosed in Japanese Priority Patent Application JP 2008-256676 filed in the Japan Patent Office on Oct. 1, 2008, the entire contents of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A battery controller comprising:
a temperature detecting section including at least one temperature detecting element whose resistance changes with changes in the temperature of a battery cell and/or a charge/discharge control switch electrically connecting the battery cell with an external apparatus;
a first voltage divider circuit including a first resistive element connected in series with the temperature detecting element of the temperature detecting section;
a second voltage divider circuit including a second resistive element connected in series with the temperature detecting element of the temperature detecting section; and
a control section applying a reference voltage to either of the first and second voltage divider circuits while switching the voltage divider circuit to apply the reference voltage such that the value of a voltage applied to the temperature detecting element according to a voltage dividing ratio between the first resistive element or the second resistive element and the voltage divider circuit changes in proportion to changes in the temperature of the battery cell and/or the charge/discharge control switch, and controlling the charge/discharge control switch such that the external apparatus is electrically connected to the battery cell when the temperature of the battery cell and/or the charge/discharge control switch detected based on a voltage division output of the voltage divider circuit is not lower than a first temperature and not higher than a second temperature.

2. A battery controller according to claim 1, wherein
the temperature detecting section includes one temperature detecting element; and
each of the first voltage divider circuit and the second voltage divider circuit is connected with the same temperature detecting element.

3. A battery controller according to claim 1, further comprising
a difference information storing section for storing difference information indicating a temperature difference between a detected temperature obtained by multiplying the value of the voltage applied to the temperature detecting element by a predetermined conversion coefficient and the temperature of the battery cell and/or the charge/discharge control switch, wherein
the control section detects the temperature of the battery cell and/or the charge/discharge control switch from the detected temperature obtained by multiplying the value of the voltage applied to the temperature detecting element by the predetermined conversion coefficient and the difference information stored in the difference information storing section and controls the charge/discharge control switch such that the external apparatus is electrically connected to the battery cell when the temperature of the battery cell and/or the charge/discharge control switch is not lower than the first temperature and not higher than the second temperature.

4. A battery controller according to claim 3, wherein the control section controls the charge/discharge control switch such that the external apparatus is kept electrically connected to the battery cell until predetermined time passes after the temperature of the battery cell and/or the charge/discharge control switch falls below the first temperature.

5. A battery control method comprising the steps of:
applying a reference voltage to either of a first voltage divider circuit including a first resistive element and a second voltage divider circuit including a second resistive element while switching the voltage divider circuit to apply the reference voltage, the first resistive element being connected in series with at least one temperature detecting element and having resistance changing with changes in the temperature of a battery and/or a charge/discharge control switch electrically connecting the battery cell with an external apparatus, the second resistive element being connected in series with the temperature detecting element, the reference voltage being applied such that a voltage applied to the temperature detecting element according to a voltage dividing ratio between the first resistive element or the second resistive element and the voltage divider circuit changes in proportion to changes in the temperature of the battery cell and/or the charge/discharge control switch; and
controlling the charge/discharge control switch such that the external apparatus is electrically connected to the battery cell when the temperature of the battery cell and/or the charge/discharge control switch detected based on a voltage division output from the voltage divider circuit to which the reference voltage is applied is not lower than a first temperature and not higher than a second temperature.

6. A battery comprising:
a battery cell;
a charge/discharge control switch electrically connecting the battery cell with an external apparatus;
at least one temperature detecting element whose resistance changes with changes in the temperature of a battery cell and/or a charge/discharge control switch electrically connecting the battery cell with an external apparatus;
a first voltage divider circuit including a first resistive element connected in series with the temperature detecting element;
a second voltage divider circuit including a second resistive element connected in series with the temperature detecting element; and
a control section applying a reference voltage to either of the first and second voltage divider circuits while switching the voltage divider circuit to apply the reference voltage such that a voltage applied to the temperature detecting element according to a voltage dividing ratio between the first resistive element or the second resistive element and the voltage divider circuit changes in proportion to changes in the temperature of the battery cell and/or the charge/discharge control switch, the control section controlling the charge/discharge control switch such that the external apparatus is electrically connected to the battery cell when the temperature of the battery cell and/or the charge/discharge control switch detected based on a voltage division output of the voltage divider circuit is not lower than a first temperature and not higher than a second temperature.
